(19) United States
(12) Patent Application Publication
(10) Pub. No.: US 2021/0172736 A1
(43) Pub. Date: Jun. 10, 2021

(54) SUPPORTING A DETERMINATION OF FLOOR HEIGHTS

(71) Applicant: HERE Global B.V., Eindhoven (NL)

(72) Inventors: Pavel IVANOV, P (FI); Lauri WIROLA, P (FI); Muhammad Irshan KHAN, P (FI)

(73) Assignee: HERE Global B.V., Eindhoven (NL)

(21) Appl. No.: 16/770,289

(22) PCT Filed: Dec. 8, 2017
(86) PCT No.: PCT/EP2017/081989

§ 371 Date: Jun. 5, 2020

(51) Int. Cl. G01C 5/06; G08B 21/18; H04W 4/33; H04W 4/029; H04W 4/02; G01C 21/20

(52) U.S. Cl. CPC G01C 5/06; G08B 21/18; G01C 21/206; H04W 4/029; H04W 4/025; H04W 4/33

(57) ABSTRACT

A system correlates tracked changes in altitude, which are based on data provided by a barometer or a pressure altimeter of a mobile device while a user of the mobile device moves around in a multi-story building, with changes of floors indicated via a user interface of the mobile device. Heights of floors of the building are determined based on the correlation. The determined heights of floors may then be stored for future use.

### FIELD OF THE DISCLOSURE

The invention relates to the field of positioning and more specifically to supporting a determination of the heights of floors in a multi-story building.

### BACKGROUND

Satellite signal based positioning technologies, which are mainly used outdoors, are usually not suited to deliver a satisfactory performance when used for indoor positioning, since satellite signals of global navigation satellite systems (GNSS), like the global positioning system (GPS), do not penetrate through walls and roofs strongly enough for an adequate signal reception indoors. Thus, these positioning technologies are not able to deliver a performance indoors that would enable seamless, equal and accurate navigation experience outdoors and indoors.

Therefore, several dedicated solutions for indoor positioning have been developed and commercially deployed during the past years. Examples comprise solutions that are based on pseudolites, which are ground based GPS-like short-range beacons, ultra-sound positioning solutions, Bluetooth™ based positioning solutions, Bluetooth low energy (BLE) based positioning solutions, cellular network based positioning solutions and wireless local area network (WLAN) based positioning solutions.

A WLAN based positioning solution, for instance, may be based on modeling the WLAN radio environment at a site as a radio map using results of measurements on radio signals at the site. The modelled radio map may then enable an accurate horizontal positioning within the coverage of the radio map and reliable floor detection.

In a first phase, which may be called radiomapping phase, samples containing a respective geolocation—e.g. in the form of latitude, longitude and altitude or of Cartesian coordinates x, y and floor number—and results of radio measurements at this location—e.g. detected WLAN access point identities and associated received signal strength (RSS) values—are collected.

The collected samples are used for creating the radio map for the site, which allows understanding how the radio signals behave at the site. That is, the radio map allows determining which radio signals may be expected at each location of the site.

In a second phase, which may be called positioning phase, the positions of mobile devices at the site may be determined using the created radio map. When a mobile device observes certain radio signals at a certain location of the site, the signal strengths of the radio signals can be compared to the radio map for the site, a best match resulting in the desired location information.

A similar approach could be used for a positioning that is based on other types of terrestrial radio transmitters or on a combination of different types of terrestrial radio transmitters.

The samples for the creation of a radio map may be collected in a continuous background process, in which mobile user devices of a large number of users are automatically reporting results of measurements along with associated information on the respective location of measurement to a server. This approach is also referred to as crowd-sourcing. In this approach, the required locations of measurements may be determined automatically as well, e.g. by means of a satellite signal based positioning or a cellular network based positioning. Alternatively or in addition, special survey personnel may be instructed to collect radio samples in a systematic manner, possibly using special tools. In this approach, the locations of measurements may be input manually. While automated crowd-sourcing may enable indoor localization in large number of buildings in a cost efficient manner, a systematic manual data collection may be the best option, when high accuracy is desired.

### SUMMARY OF SOME EMBODIMENTS OF THE INVENTION

An example embodiment of a method comprises correlating tracked changes in altitude, which are based on data provided by a barometer or a pressure altimeter of a mobile device while a user of the mobile device moves around in a multi-story building, with changes of floors indicated via a user interface of the mobile device. The method moreover comprises determining heights of floors of the building based on the correlation. The method moreover comprises causing storage of the determined heights of floors for future use. The method may be performed by a single apparatus or by several apparatuses in cooperation.

An example embodiment of a first system comprises means for causing at least one apparatus to perform the actions of any embodiment of the presented method.

The means of the system may be implemented in hardware and/or software. They may comprise for instance at least one processor for executing computer program code for realizing the required functions, at least one memory storing the program code, or both. Alternatively, they may comprise for instance circuitry that is designed to realize the required functions, for instance implemented in a chipset or a chip, like an integrated circuit.

An example embodiment of a second system comprises at least one processor and at least one memory including computer program code, the at least one memory and the computer program code configured to, with the at least one processor, cause at least one apparatus at least to perform the actions of any embodiment of the presented method.

Any of the described systems may comprise only the indicated components or one or more additional components, like a memory for a database. Any of the described systems may be a mobile device or form a part of a mobile device or comprise at least one mobile device. Any of the described systems may be a server or form a part of a server or comprise at least one server. Any of the described systems may comprise at least one mobile device and at least one server configured to perform any of the described methods in cooperation.

Moreover an example embodiment of a non-transitory computer readable storage medium, in which computer program code is stored, is presented. The computer program code causes at least one apparatus to perform the actions of any embodiment of the presented method when executed by at least one processor.

The computer readable storage medium may be for example a disk or a memory or the like. The computer program code may be stored in the computer readable storage medium in the form of instructions encoding the computer-readable storage medium. The computer readable storage medium may be intended for taking part in the operation of a device, like an internal program memory or like an integrated or exchangeable memory card, or it may be intended for distribution of the program code, like an optical disc or memory stick or memory card.

It is to be understood that any embodiment of the computer program code by itself has to be considered an example embodiment of the invention as well. The computer program code may also be distributed to several computer readable storage mediums.

In certain embodiments, any of the presented methods is an information providing method, and any of the presented first systems is an information providing system. In certain embodiments, the means of the presented first system are processing means.

In certain embodiments, any of the presented methods is a method for supporting a determination of heights of floors. In certain embodiment, any of the presented systems is a system for supporting a determination of heights of floors.

It is to be understood that any feature presented for a particular example embodiment may also be used in combination with any other described example embodiment of any category and any aspect.

Further, it is to be understood that the presentation of the invention in this section is merely exemplary and non-limiting.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of an example embodiment of a system;

FIG. 2 is a flow chart illustrating an example embodiment of a method;

FIG. 3 is a schematic block diagram of a further example embodiment of a system;

FIG. 4 is a flow chart illustrating an example embodiment of first operations in the system of FIG. 3; and

FIG. 5 is a flow chart illustrating an example embodiment of further operations in the system of FIG. 3.

### DETAILED DESCRIPTION OF THE FIGURES

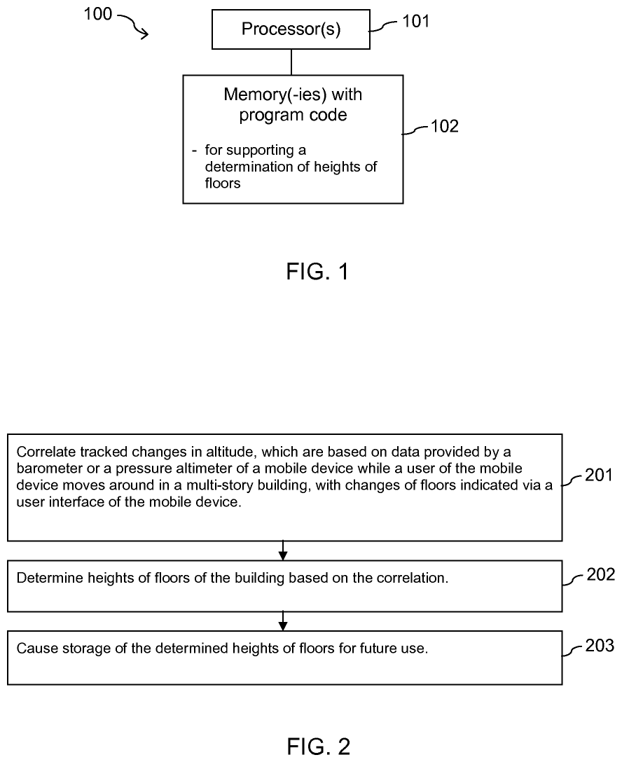

FIG. 1 is a schematic block diagram of an example embodiment of a system 100 according to the invention. System 100 comprises at least one processor 101 and, linked to the at least one processor 101, at least one memory 102. The at least one memory 102 stores computer program code for supporting a determination of heights of floors. The computer program code may be example computer program code according to the invention, and the at least one memory 102 may be an example computer readable medium according to the invention. The at least one processor 101 is configured to execute computer program code stored in the at least one memory 102 in order to cause at least one apparatus to perform desired actions.

System 100 may be a mobile device, e.g. in the form of a regular mobile communication device supplemented with suitable computer program code or in the form of a special survey tool. System 100 may equally be a module, like a chip, circuitry on a chip, for a mobile device. Alternatively, system 100 may be a stationary computer, like a server, a module for a computer or comprise a plurality of stationary computers. Alternatively, system 100 may comprise at least one mobile device and in addition at least one server. Optionally, system 100 may comprise various other components, like radio communication interfaces, a user interface, a barometer or pressure altimeter, a further memory, a further processor, etc.

An example operation of system 100 will now be described with reference to the flow chart of FIG. 2. The operation is an example embodiment of a method according to the invention. The at least one processor 101 and the program code stored in the at least one memory 102 cause at least one apparatus to perform the operation when program code is retrieved from the at least one memory 102 and executed by the at least one processor 101. The at least one apparatus that is caused to perform the operation may be system 100, comprise system 100 or be a part of system 100.

The at least one apparatus correlates tracked changes in altitude, which are based on data provided by a barometer or a pressure altimeter of a mobile device while a user of the mobile device moves around in a multi-story building, with changes of floors indicated via a user interface of the mobile device. (action 201) The user of the mobile device may be responsible for conducting a survey of the building. The user may be instructed to indicate a current floor by means of a user input to the mobile device at least whenever there has been a change of floor after a preceding user input. A barometer may output atmospheric pressure values, and changes in such pressure values may be converted into changes in altitude. A pressure altimeter may include a barometer and convert atmospheric pressure values provided by the barometer into altitude values and output such altitude values. The altitude values may or may not be calibrated based on a reference altitude and thus be more or less exact. Such altitude values may then be converted into changes in altitude. It is to be understood that the at least one apparatus performing action 201 may or may not be responsible for converting changes in pressure to changes in altitude, and that the at least one apparatus performing action 201 may or may not be responsible for tracking the changes in altitude.

The at least one apparatus determines heights of floors of the building based on the correlation. (action 202) The height of a floor is to be understood to be the difference in altitude, or delta-altitude, between this floor and the next higher floor.

The at least one apparatus causes storage of the determined heights of floors for future use. (action 203) The storage is caused such that the height of a respective floor is associated with an index or another indication of the floor. In some embodiments, height and indication of floor may be caused to be stored in action 204. In other embodiments, the height of a floor may be stored e.g. in a field associated with a previously stored indication of the floor. Before storage, such a field may be empty; or it may already comprise a value, if the current storage of heights constitutes an update of previously stored heights.

The invention is based on the consideration that barometer data may be used for detecting changes in altitude and for supporting a user in selecting a floor in a building. For instance, when barometer data indicates an accumulated altitude change of 3.2 meters, which may be an assumed standard floor height, an apparatus may automatically assume that the user changed the floor by one floor (up or down). However, this automation may lead to negative user experience in buildings in which the floor height is not a standard one, as there may often be a wrong selection of floor. In general, information on floor heights is not readily available in site maps.

Certain embodiments of the invention therefore provide that a survey of a building is used as a basis for learning the height of floors in the building. The height of floors is estimated by mapping tracked changes in altitude derived from changes in atmospheric pressure occurring during the survey to changes of floor indicated by a user during the survey. Such a survey may be performed separately or in combination with other tasks, for instance during a first collection of radio samples (e.g. in the form of fingerprints) for a creation of a radio map for the building.

Certain embodiments of the invention may have the effect that they allow improving the positioning performance, either because they ensure that correct floor data may be used during radio map creation, or because they ensure that the radio map data for the correct floor may be selected right away in positioning operations.

System 100 illustrated in FIG. 1 and the method illustrated in FIG. 2 may be implemented and refined in various ways.

Certain embodiments further comprise tracking the changes in altitude based on the data provided by a barometer or a pressure altimeter of the mobile device while the user of the mobile device moves around in the multi-story building.

The heights of floors may be determined based on a single survey of a building by a single user, in particular if this survey is a systematic survey specifically and exclusively for determining the heights of floors.

However in certain embodiments, heights of floors of the building may be determined based on data of a barometer or a pressure altimeter of a plurality of mobile devices and changes of floors indicated via a user input of the plurality of mobile devices. Alternatively or in addition, heights of floors of the building may be determined based on data of a barometer or a pressure altimeter and changes of floors indicated via a user input collected at different occasions of a user of the mobile device moving around in the multi-story building. This may have the effect that more data may be available for determining the floor heights in a reliable manner, in particular if it is not the primary task of the user to collect information for the determination of the floor heights. It is to be understood that an initial estimation of floor heights based on a limited amount of data may also be updated once more data has been collected.

In certain embodiments, determining heights of floors comprises determining delta-altitudes of floors for each of a plurality of floor pairs. In the case that a plurality of delta-altitudes are determined for a particular floor pair, these embodiments may further comprise selecting an average or a median of the determined plurality of delta-altitudes as a final delta-altitude for the particular floor pair, or selecting a range of the determined plurality of delta-altitudes as a final delta-altitude for the particular floor pair. A range may also be defined by an average or a median delta-altitude and an individually determined maximum deviation. In the case that a plurality of delta-altitudes are determined for a floor pair, delta-altitudes that deviate in view of a predetermined criterion from other delta-altitudes of the plurality of delta-altitudes may be discarded before a final delta-altitude is determined. Discarding outliers may have the effect that data that is based on an erroneous user indication of a floor may be omitted from consideration.

In certain embodiments determining heights of floors comprises determining the delta-altitudes of floors for each of a plurality of floor pairs of the building, at least one of the floor pairs being non-subsequent floors. In this case, a delta-altitude determined for at least one floor pair of the building may be verified based on delta-altitudes determined for other floor pairs of the building. This may have the effect that the reliability of floor heights that are determined based on delta-altitudes between subsequent floors may be improved further. Furthermore, not only the heights of floors may be caused to be stored, but the delta-altitudes for all possible floor pairs may be stored for future use. This may have the effect that in case a mobile device making use of the stored data moves upwards or downwards by several floors at once, the mobile device may not have to take account of the sum of individual floor heights, but may consider right away the associated delta-altitude for the concerned floor pair.

In certain embodiments correlating the changes in altitude with changes of floors indicated via a user interface of the mobile device comprises considering only changes in altitude that exceed a predetermined value within a moving time window.

Since air pressure constantly changes depending on many environmental conditions (e.g. weather, air conditioning), a pressure change may indicate an altitude change of several meters in tens of minutes, even if the altitude of a mobile device has not changed. To minimize the effect of changes in environmental conditions during the collection of pressure data for determining floor heights, a moving time window approach may be used. It may be assumed for instance that the user changes floor within tens of seconds. By choosing an appropriate window length, e.g. one minute, it is possible to detect the true altitude changes despite of environmental changes. If an indicated altitude change is less than one meter over the one-minute window, then it may safely be assumed that there was no altitude change at all within that minute. If there is an indicated altitude change of more than one meter, the altitude change may be added to a cumulative altitude change. In such a way, it is possible to essentially eliminate indicated altitude changes that are due to slow pressure variations caused by environmental conditions rather than due to actual changes in altitude. In some embodiments, relevant changes in altitude may be accumulated until the altitude change in the window falls short of one meter. The accumulated altitude may then be recorded and reset for further tracking. In other embodiments, changes in altitude may be tracked continuously, starting from any point in time, and recorded for future learning of floor heights. It is to be understood that the window does not have to be set to one minute and that the required minimum change within a window does not have to be set to one meter; these parameters may also be set to some other suitable values.

In certain embodiments, a determined floor height may be indicated to a user of the mobile device for confirmation, to enable a plausibility check.

In certain embodiments, the barometer data or pressure altimeter data and the floors indicated via the user interface of the mobile device are received during a collection of data for a radio map for the building. This may have the effect that the time of a user surveying the building may be used efficiently.

The determined and stored floor heights may be provided for different purposes. They may be provided for positioning of mobile devices in the building. They may be provided for supporting a correct selection of a floor during data collection for a radio map. During a data collection, the floor has to be selected on each floor on which a survey is to be carried out. Experience shows that surveying persons make quite many mistakes when manually selecting the floor without any assistance, e.g. in office buildings, where floors may resemble each other. The floor heights may be provided for automatically detecting a floor in the building and thus invisibly to the user—either during data collection for a radio map or during positioning computations. They may be provided for automatically detecting a floor in a crowd sourced data collection for a radio map in the building. This may enable an efficient and reliable collection of a large amount of data for a radio map using crowd sourcing. Alternatively, the floor heights may be provided for suggesting a floor to a user in the building, which is to be confirmed or rejected by the user. It is to be understood that a rejection may optionally comprise a correction. This may be used in particular during data collection for a radio map and may significantly improve the quality of the floor selection. Alternatively, the floor heights may be provided for verifying a floor input by a user in the building and for outputting a warning in the case of a discrepancy.

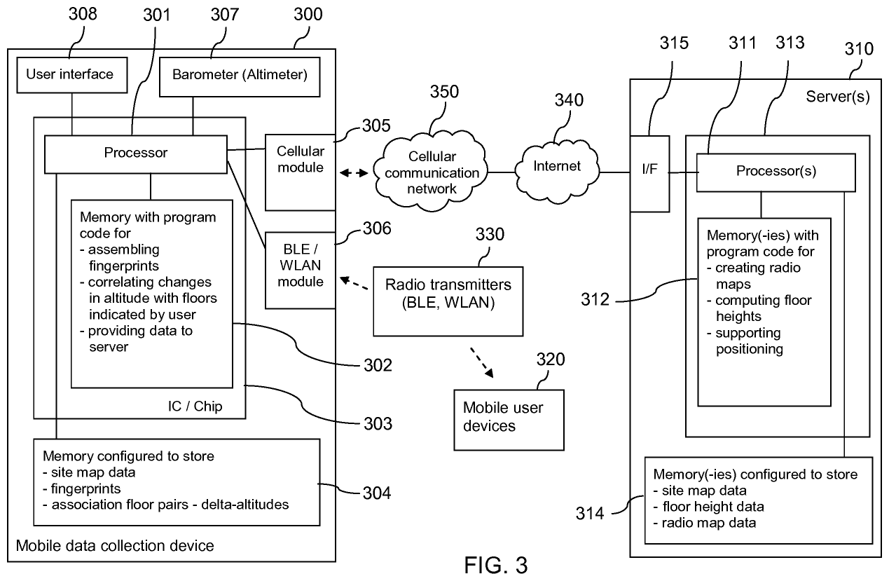

FIG. 3 is a schematic block diagram of an example embodiment of a system supporting a determination of heights of floors of a multi-story building, for instance a large office building.

The system comprises a mobile data collection device 300, a server 310 and mobile user devices 320. The system further comprises a plurality of stationary radio transmitters 330. The Internet 340 may enable a connection between server 310 and other devices. A mobile communication network 350 and/or at least one WLAN may enable mobile devices 300, 320 to access the Internet 340 and thus server 310.

Mobile data collection device 300 may be for instance a regular mobile terminal, like a smartphone or general purpose tablet PC. Alternatively, it may be for instance a special survey tool. The user of mobile data collection device 300 may belong for instance to survey personnel. Mobile data collection device 300 comprises a processor 301 that is linked to a first memory 302, to a second memory 304, to a cellular communication module 305, to at least one other radio communication module 306, to a barometer or pressure altimeter 307 and to a user interface 308.

Processor 301 is configured to execute computer program code, including computer program code stored in memory 302, in order to cause mobile data collection device 300 to perform desired actions. It is to be understood that processor 301 may comprise or have access to a working memory for this purpose, for example in the form of a random access memory (not shown).

Memory 302 stores computer program code for assembling radio samples—by way of example in the form of fingerprints—based on radio measurements, computer program code for tracking changes in altitude based on barometer data and for correlating the changes with indicated floors, and computer program code for providing collected data to server 310. Memory 302 may also store any other kind of computer program code. Memory 302 may also store for instance an operating system for device 300. In addition, memory 302 may store any kind of data.

Processor 301 and memory 302 may optionally belong to a module 303, like a chip or an integrated circuit or any other kind of processing circuitry, which may comprise in addition various other components, for instance a further processor or a further memory.

Memory 304 is configured to store data of a database (DB), including site map data, measurement results in the form of fingerprints and associations of floor pairs with delta-altitudes. In addition, memory 304 may also store any other kind of data.

Cellular communication module 305 is configured to enable access to nodes of cellular communication network 350 and thus to enable a communication with other devices, like server 310, for instance via the Internet 340. Cellular communication module 305 may support cellular communication according to any desired mobile communication standard, like GSM, CDMA2000, UMTS, LTE or any other current or future standard.

The at least one other radio communication module 306 may comprise a BLE module 306 and/or a WLAN module 306. A BLE module 306 is configured to receive radio signals transmitted by BLE beacons 330. A WLAN module 306 is configured to communicate with WLAN access points 330. Alternatively or in addition to cellular communication module 305, WLAN module 306 may enable mobile data collection device 300 to access server 310 via a WLAN and further via the Internet 340.

Barometer 307 is configured to measure the atmospheric pressure. In case a pressure altimeter 307 is employed instead of a barometer, altimeter 307 may be configured to convert atmospheric pressure values provided by an internal barometer into altimeter values.

User interface 308 may comprise for instance a touchscreen.

It is to be understood that mobile data collection device 300 may comprise various other components, like a satellite navigation system module.

Server 310 may be for instance a dedicated location server or a general purpose server. It may be provided specifically for the above mentioned multi-story building or for a plurality of sites. Server 310 comprises a processor 311 that is linked to a first memory 312, to a second memory 314 and to a communication interface 315.

Processor 311 is configured to execute computer program code, including computer program code stored in memory 312, in order to cause server 310 to perform desired actions. It is to be understood that processor 311 may comprise or have access to a working memory for this purpose, for example in the form of a random access memory (not shown).

Memory 312 stores computer program code for generating and storing radio maps for a site based on received fingerprints, computer program code for computing and storing floor heights, and computer program code for supporting a positioning of mobile devices. Memory 312 may also store any other kind of computer program code. Memory 312 may also store for instance an operating system for server 310. In addition, memory 312 may store any kind of data.

Processor 311 and memory 312 may optionally belong to a module 313, like a chip or a plug-in board, which may comprise in addition various other components, for instance a further processor or a further memory.

Memory 314 is configured to store data of a database (DB), including radio map data, site map data and floor height data. In addition, memory 314 may also store any other kind of data.

Communication interface 315 is configured to enable a communication with other devices, like mobile devices 300, 320, via the Internet 340.

It is to be understood that the functions of server 310 may also be performed in the cloud in a distributed manner.

Mobile data collection device 300 and server 310 may be or belong to a system according to the invention.

Radio transmitters 330 may, for instance, be or belong to WLAN access points of at least one WLAN and/or be or belong to BLE beacons. They may be distributed at the site such that at least one radio transmitter 330 may be observed at essentially each location of the site at which a positioning of mobile user devices 320 is to be supported. Each of radio transmitters 330 may be configured to transmit radio signals at regular intervals. These radio signals are provided to be used by mobile user devices 320 for positioning purposes. Optionally, they may be used for other purposes in addition.

Mobile user devices 320 represent devices that may desire to know their own position in the building. The position may be requested for instance by an internal application or by some other device. Any of mobile user devices 320 may be for instance a regular mobile terminal, like a smartphone or general purpose tablet PC, or it may be for instance an Internet of Things (IoT) device, like a smart watch or a smart band, etc. They are configured to perform measurements on signals transmitted by at least one type of radio transmitters 330. They are furthermore configured to compute their own position based on radio map data provided by server 310 and/or to obtain a computed position from server 310 upon request. Any of mobile user devices 320 may be configured to access server 310 for instance via a cellular communication network 350 and/or some WLAN and further via the Internet 340. It is to be understood that instead of or in addition to mobile user devices, also a positioning of other mobile devices, like autonomous mobile devices, may be supported.

Cellular communication network 350 may be of any present or future technology, like GSM, CDMA2000, UMTS or LTE.

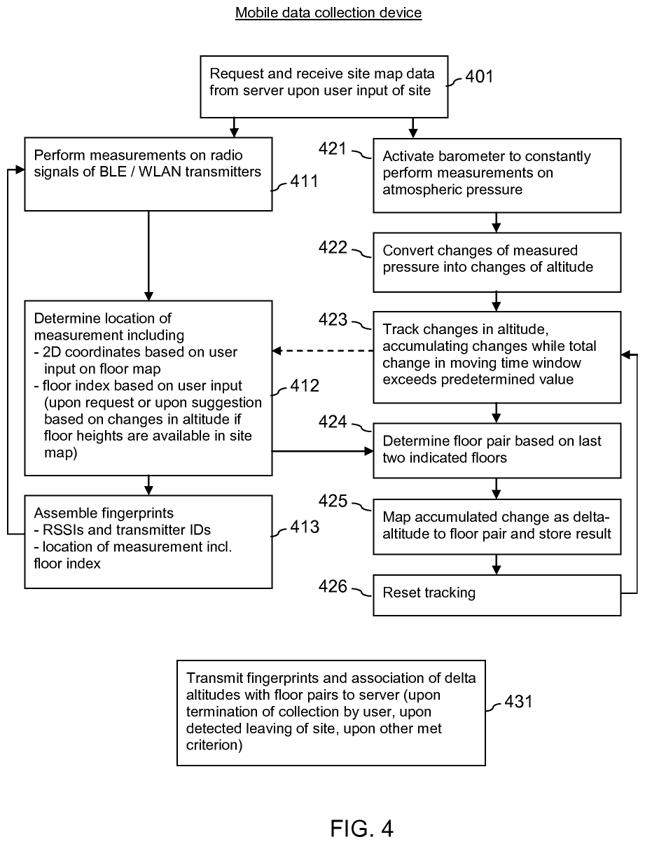

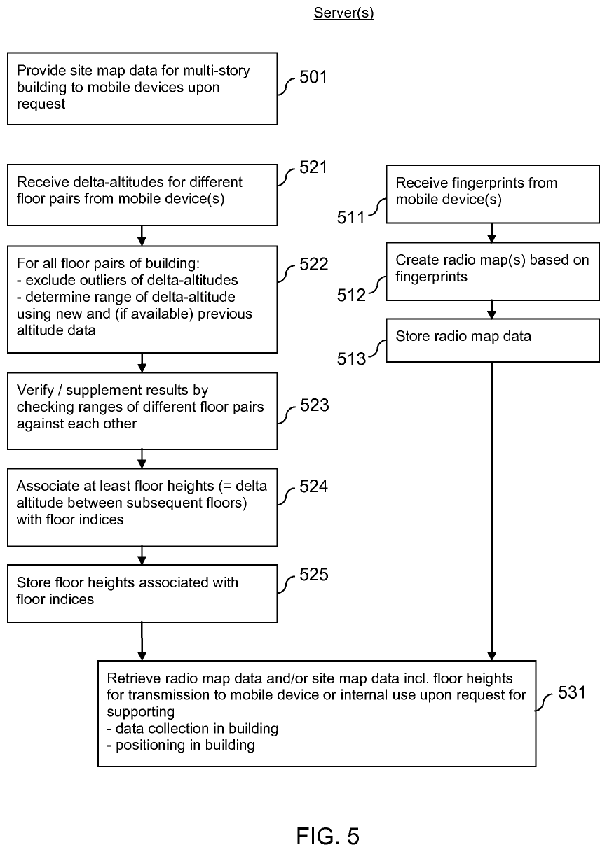

FIGS. 4 and 5 illustrate example operations in the system of FIG. 3.

FIG. 4 is a flow chart illustrating example operations at mobile data collection device 300. Processor 300 and some of the program code stored in memory 300 cause mobile data collection device 300 to perform the presented actions when corresponding program code is retrieved from memory 302 and executed by processor 301. The operations comprise a first strand illustrated on the left hand side, which relates to the collection of data for a radio map; and a second strand illustrated on the right hand side, which relates to a collection of data for a determination of floor heights.

In the building, all radio transmitters 330 regularly transmit radio signals including at least their identifier (ID). The identifier may be for instance a medium access control (MAC) address of a transmitting BLE beacon, or a basic service set identification (BSSID) of a WLAN access point in the form of a MAC address or of a random number.

In order to support a positioning of mobile user devices 320 in the building based on these radio signals, at least one radio map has to be created for the building. The at least one radio map defines which RSS values from which radio transmitters 330 may be expected to be detected by a mobile user device 320 at each location of the building. A single three-dimensional radio map may be created for the building, or a separate radio map may be created for each floor of the building. Mobile data collection device 300 is used to survey the building to obtain the required data for the radio map(s), which is then created by server 310. Mobile data collection device 300 is used in addition to collect data enabling server 310 to determine the height of the floors of the building.

When the user of mobile data collection device 300 enters the building for the survey, the user may select an installed data collection application. In response, mobile data collection device 300 may activate the application. Once activated, the application may present an input mask via the touchscreen of user interface 308, which enables the user to select the building among different offered sites and to indicate the floor where the user is located as an initial floor for the survey. This may be the ground floor, but it could also be a basement or the top floor or any other floor of the building. Mobile data collection device 300 receives a user input with respect to building and initial floor.

Upon the user input, mobile data collection device 300 requests and receives site map data for the indicated building from server 310. (action 401) A map of the indicated initial floor, which is based on the retrieved site map data, may be presented on the touchscreen of user interface 308. The floor map serves for orientation and enables the user to indicate horizontal positions. Initially, the site map data may not comprise any information on the height of the floors of the building.

Then, mobile data collection device 300 performs measurements on radio signals using module 306 while the user of mobile data collection device 300 moves around in the building. The measurement results include in each instance the IDs of radio transmitters 330 of which radio signals are currently detected and RSS values of the detected radio signals. (action 411)

In parallel, barometer 307 is activated to constantly perform measurements on the atmospheric pressure and to provide the resulting pressure in Pascal (Pa) in regular intervals, for instance once per second or once every 10 seconds. (action 421)

Mobile data collection device 300 converts the changes in pressure provided by barometer 307 into individual changes of altitude. (action 422) For the conversion, it may be assumed that the pressure decreases with rising altitude by about 12 Pa per meter, and vice versa, which is the approximate relation at sea level.

In case the barometer of mobile data collection device 300 is an integral part of a pressure altimeter 307, pressure altimeter 307 may convert the absolute pressure values provided by the barometer into absolute altitude values. Pressure altimeter 307 may optionally be calibrated for the conversion by the user for other applications, but this is not required for the operations of FIG. 4. Mobile data collection device 300 may then determine individual changes in altitude based on the absolute altitude values provided by pressure altimeter 307.

Mobile data collection device 300 tracks the individual changes in altitude, while monitoring the total changes within a moving time window. The moving time window may have a length of one minute, for example. As soon as the total change within the window exceeds a threshold of one meter, the individual changes are accumulated until the total change within the window falls short of the threshold of one meter. (action 423) By way of example, always the oldest individual change within the moving time window may be added to the accumulated change. Alternatively, the total change within the first window in which the threshold is exceed may be used as a basis of the accumulated change, and the newest individual change in each subsequent window is added to the accumulated change until the total change within the latest window falls short of the threshold. Accumulated changes may comprise a direction of change and a magnitude in meters. The moving time window may also have any other suitable length, for instance 30 seconds. The window may be selected to be sufficiently short to ensure that the covered time does not allow for changes above the set threshold due to other effects than real changes in altitude. The threshold may equally have any other suitable value, for instance 0.8 meter. It may be selected to be lower than assumed minimum height of a floor, and it may be selected to be sufficiently high to indicate real altitude changes within the selected window.

Coming back to the processing of the results of the radio measurements, mobile data collection device 300 furthermore determines a respective location of measurement. (action 412)

The user input may include an indication of his current horizontal position, identified by the user touching the corresponding location in a floor map displayed on the touchscreen. A request to input a current position may be triggered mobile data collection device 300 for instance whenever new measurement results have been obtained in action 411. Alternatively, the user may indicate the position whenever appropriate to obtain an even distribution of indicated positions on the floor. A touched position in a floor map may be converted by mobile data collection device 300 for instance into a set of coordinates x, y of a Cartesian coordinate system for the site, or into geographic coordinates.

The location of measurement includes in addition the current floor on which the user is located. The floor is indicated by the user as well.

The user may be instructed for the survey to input an indication of the current floor at least whenever there was a change of floor and before the input of a new position on the new floor. Alternatively, the user may be requested to input an indication of a floor, whenever accumulated changes in altitude detected in action 423 indicate a new floor. If indications of individual floor heights are already available, the latest accumulated changes in altitude may also be used for suggesting a particular floor to a user when changes in altitude in action 423 indicate a new floor, as will be explained further below. Initially, no floor heights are available. Request or suggestion may be provided to the user for instance as soon as the total change in the moving time window does not exceed one meter anymore after the latest accumulated changes have exceeded a predetermined value, e.g. 2.5 meters. A floor indicated or confirmed by a user may be used as a part of the location of measurement for all subsequent measurement results, until an indication of a new floor is provided. A particular floor may be indicated by inputting or selecting a floor number or floor index.

Indicating a new floor may result in an update of the floor map presented on the touchscreen of user interface 308.

Mobile data collection device 300 assembles a fingerprint for each determined location of measurement. (action 413) Each fingerprint includes a received signal strength indicator (RSSI) for all BLE and WLAN radio signals received at the location of measurement, the associated IDs of radio transmitters 330 transmitting these radio signals and an indication of the location of measurement including the floor, e.g. in the form of a floor index. It is to be understood that instead of RSSIs, the received signal strengths of radio signals may be represented for instance by a physical Rx level in dBm with a reference value of 1 mW, etc. Furthermore, other characteristics of radio signals may be used instead of the radio signal strength, for example path losses of radio signals. The assembled fingerprints are stored in memory 304. If the location of measurement is determined in action 412 independently of the actual measurements in action 411, RSSIs and radio transmitter IDs resulting from the latest measurements before the determination of a location of measurement may be used. Additional information, like timestamps, may be included as well in the assembled fingerprints.

In a variation, a database making use of memory 304 may be structured such that assembled data may be stored separately for each floor. In this case, it may not be needed to include an identification of a floor in each fingerprint as a part of the location of measurement; instead, each fingerprint may be stored in an area provided for the indicated floor so that the information is available indirectly. It is to be understood that the radio samples may also be stored in other form than in fingerprints. For example, RSSIs and associated locations of measurement may be stored per radio transmitter ID, etc.

Mobile data collection device 300 then continues with performing measurements, determining positions and assembling and storing fingerprints as described with reference to actions 411 to 413, until the user terminates the collection via the user interface or until it is detected that the user has left the building or until some other criterion is met.

Whenever a new floor number is indicated by the user in action 412 in this loop, a floor pair including this floor and the preceding floor is determined. (action 424) The floor pair may be identified for instance by the indices of the floors.

Mobile data collection device 300 maps the currently accumulated change of altitude as delta-altitude to the determined floor pair. The mapping is stored in memory 304. (action 425)

Then, mobile data collection device 300 resets the tracking of changes in altitude by setting the currently accumulated altitude value to zero. (action 426)

Mobile data collection device 300 then continues with tracking changes in altitude, determining floor pairs and mapping accumulated changes to a floor pair as described with reference to actions 423 to 426, until the user terminates the collection via the user interface or until it is detected that the user has left the building or until some other criterion is met.

When the user terminates the collection via the user interface or when it is detected that the user has left the building or when some other criterion is met, mobile data collection device 300 retrieves the stored fingerprints from memory 304 and transmits them to server 310. A possible other criterion may include in this case for instance the termination of the data collection on a particular floor. When the user terminates the collection via the user interface or when it is detected that the user leaves the building or when some other criterion is met, mobile data collection device 300 retrieves in addition the stored mapping of delta-altitudes to floor pairs from memory 304 and transmits them to server 310. In this case, a possible other criterion may include for instance the availability of at least two delta-altitudes associated with each floor. The transmission of fingerprints and delta-altitude information may take place in a single message or in separate messages. (action 431)

It may be noted that in order to capture all changes in altitude, barometer 307 needs to record readings all the time—also when no radio data collection is performed.

It may further be noted that in case delta-altitudes are provided to server 310 before the collection of the results of radio measurements has been completed in the building, mobile data collection device 300 may receive an update on the site map data once or several times.

This update may include an estimate of the height of the floors in the building. If an estimate of the height of each floor is known, mobile data collection device 300 may determine a change of floor based on the accumulated change in altitude resulting in action 423 and suggest a new floor to the user in action 412 based on the available information of individual floor heights. As a result, the user only has to confirm or correct the suggestion, which may reduce errors in the input of floors indices. In some embodiments, delta-altitudes between subsequent floors stored in memory 304 may also be used as a first estimate for the heights of floors.

FIG. 5 is a flow chart illustrating example operations at server 310. Processor 310 and some of the program code stored in memory 310 cause server 310 to perform the presented actions when corresponding program code is retrieved from memory 312 and executed by processor 311. The operations comprise a first strand illustrated on the right hand side, which relates to the creation of radio maps, and a second strand illustrated on the left hand side, which relates to the determination of floor heights.

Server 310 may provide site map data for a particular multi-story building to mobile devices 300, 320 upon request. (action 501) The data may be requested and received for instance by mobile data collection device 300 in action 401 of FIG. 4. If available, the data may comprise information on the height of the floors of the building.

Server 310 may receive fingerprints from mobile data collection device 300. (action 511) When server 310 receives fingerprints for a particular site from a mobile data collection device, it may store the data in memory 314 for later processing or it may process the data right away. The data may be data transmitted by mobile data collection device 300 in action 431 of FIG. 4. The data may be stored for later processing, in case the data collection for the particular building has not yet been completed for the time being, and further data is expected from other mobile data collection devices and/or from the same mobile data collection device 300 at a later point of time.

When sufficient fingerprints have been received for a particular building, server 310 creates at least one radio map for the building for use in positioning mobile user devices 320 that are located in the building (action 512). Server 310 may generate for instance a grid based radio map for each radio transmitter 330 for which RSSIs have been received. Each grid is defined to cover the site with the building such that each grid point corresponds to a geographical location at the site. If the site comprises several floors, a separate grid may be defined for each floor, or a single three-dimensional grid may be defined, with one dimension for the floors. Each grid based radio map may be generated by mapping the RSSI for a respective radio transmitter ID to the grid point that corresponds to a geographical location that is closest to the position (and floor) associated with the RSSI. If there are several RSSIs for the radio transmitter 330 that would be mapped to the same grid pint, some kind of average value may be used, for instance the arithmetic mean or the median value. For grid points to which no RSSIs could be mapped due to missing data from the corresponding areas at the site, RSSIs may be generated by interpolating surrounding RSSIs if possible, and by extrapolating neighboring RSSIs otherwise.

Server 310 stores the grid based radio map data. (action 513)

Alternatively or in addition to fingerprints, server 310 may receive delta-altitudes for different floor pairs from mobile data collection device 300. (action 521) Server 310 may store the data in memory 314 for later processing or it may process the data right away. The data may be data transmitted by mobile data collection device 300 in action 431 of FIG. 4. The data may be stored for later processing, in case the data collection for the particular building has not yet been completed for the time being, and further data is expected from other mobile data collection devices and/or from the same mobile data collection device 300 at a later point of time.

The received data that is eventually processed comprises information about the delta-altitude between all or most possible pairs of floors, wherein the information for a respective pair of floors may possibly comprise a plurality of determined delta-altitudes from measurements at different times and/or by different mobile data collection devices:

{floor-pair={N,N+M}; {set of delta-altitudes},
where 1<=N<number of floors AND 1<=M<=(number of floors)−N

Thus, for example, for an 8-floor building the entirety of floor pairs consists of

1 to 2, 3, 4, 5, 6, 7, 8
2 to 3, 4, 5, 6, 7, 8
3 to 4, 5, 6, 7, 8
4 to 5, 6, 7, 8
5 to 6, 7, 8
6 to 7, 8
7 to 8
where the numbers represent a respective floor index.

Therefore, there are 28 floor pairs and for each floor there is an arbitrary count of delta-altitudes. Optionally, only some of the received delta-altitudes may have been confirmed by a user input.

When sufficient delta-altitudes have been received for a particular building, server 310 determines for each pair of floors a range of delta-altitudes within which an accumulated change of altitude may be expected to lie when a user of a mobile device moves from one of the floors of the floor pair to the other. (action 522) Server 310 could simply use the highest and lowest value in each case. However, it is possible that a data set indicates a contradiction. For example, if nine out of ten measurements indicate that the height between floors one and two is in the range from 3.3 to 3.7 meters, and one user confirmation indicated that the floor height is 7.1 meters, then the last confirmation is clearly an outlier. Such outliers may be discarded by server 310. Just to provide an example, any value that deviates from a median value or an average value in either direction by more than 0.5 meter (or any other threshold value) may be discarded by server 310.

The delta-altitude for a particular floor pair of subsequent floors corresponds to the floor height of the lower floor. Thus, by collecting enough data on the altitude differences between the floors, one can reliably learn the true floor heights over time.

In addition, server 310 may verify and/or supplement the results of delta-altitudes between floor pairs by checking the ranges of different floor pairs against each other. (action 523)

While some of the obtained data is directly related to the floor heights, namely the delta-altitude between subsequent floors (e.g. 1&2, 2&3, etc.), there is also dependent data on e.g. the delta-altitude between floors 1 and 3. This information can easily be used to improve the floor height estimates too. The sum of the ranges for floors 1&2 and 2&3 should correspond for instance to the ranges for floors 1&3. Or, if only delta-altitudes for the floor pairs 1&2 and 1&3 are available, but not for the floor pair 2&3 and thus the height of floor 2, a suitable range for the height of floor 2 may be computed from the available data for the other two floor pairs.

Once at least ranges for delta-altitudes for each pair of subsequent floors have been determined and verified, server 310 causes storage of the ranges as floor heights associated with a respective floor index for the lower one of the two subsequent floors. The information may be stored in memory 314 or in the cloud. (action 525) In some embodiments, only the respective lower limit of the range may be used as floor height estimate. In some embodiments, the ranges or the lower limits of ranges of delta-altitudes for all floor pairs may be stored. This may simplify the processing at a mobile device using the information whenever the user moves by several floors at a time.

Server 310 stores the floor heights—and optionally delta-altitudes for other floor pairs than subsequent floors—e.g. as a supplement to the stored site map data for the building.

It is to be understood that it is possible to determine and store heights of floors of the building in line with actions 522 to 525 based on new delta-altitudes that have not yet been processed by server 310 and delta-altitudes that have previously been processed by server 310 for determining heights of floors of the building. Thus, a first estimate for the heights of floors may be obtained at an early stage based on a limited amount of data, which may then be improved as more delta-altitudes are received.

The determined and stored data on floor heights (or processed delta-altitudes) may be retrieved and transmitted for positioning purposes as well as for supplementing the survey of the building. (action 531)

In case server 310 receives a request from a mobile data collection device 300 to provide site map data to support a further radio data collection in the building, server 310 retrieves and provides the site map data including or along with the stored floor heights. When mobile data collection device 300 tracks changes in altitude (as described with reference to action 423 of FIG. 4), it may be assumed that the user changed floor as soon as the accumulated change of altitude exceeds the lower limit of the range of the floor height indicated for the current floor—in the case of increasing altitude—or as soon as the accumulated change of altitude exceeds the lower limit of the range of the floor height indicated for the next lower floor—in the case of decreasing altitude. Mobile data collection device 300 may wait until there is no further significant change in altitude, and map the total accumulated change of altitude to a new floor. For the mapping, mobile data collection device 300 may take account of the previous floor on which the user was known to be located and of the received information on the floor height for each floor. If delta-altitudes for all floor pairs are provided, mobile data collection device 300 may map the accumulated change in altitude directly to a suitable new floor. When a floor estimate has been determined, a user may be requested via user interface 308 to confirm a corresponding suggestion, as mentioned with reference to action 412 of FIG. 4. In some embodiments, mobile data collection device 300 may be enabled to set the current floor automatically without user input. This may result in an automatic change of floor map presented to the user and in an automatic change of floor indicated in subsequently assembled fingerprints in action 413 of FIG. 4. Both approaches may reduce human errors in the selection of the current floor on which radio measurements are carried out.

It is to be understood that once floor height information can be provided by server 310 to a mobile data collection device in action 531, mobile data collection device 300 may or may not continue mapping delta-altitudes to floor pairs as described with reference to actions 424 and 425 of FIG. 4. Actually, at this point in time, mobile data collection devices may be used for collecting data for radio maps that do not supporting such a mapping in the first place.

In case server 310 receives a request from a mobile user device 320 to support a positioning of mobile user device 320 in a particular building, server 310 may retrieve and transmit radio map data for the building as well as site map data along with associated floor height information to mobile user device 320. Mobile user device 320 may perform measurements on radio signals at a certain location in the building. The result of measurements may include an ID of all radio transmitters 330 of which radio signals are detected at the location, and an RSSI indicating the signal strength of the respectively detected radio signal. Starting e.g. from the first floor with the entrance to the building, changes in altitude may be tracked by a pressure altimeter of mobile user device 320. When accumulated changes in altitude indicate a change of floor in view of the provided floor height information, received radio map data for this floor is selected. Accumulated changes of altitude may be determined in a similar manner as described with reference to action 423 of FIG. 4. Mobile user device 320 may determine the location in the building, at which expected RSSIs for all radio transmitters 330 on the determined floor of the building fit best to the determined RSSIs. This location may then be presented as estimated position in a displayed floor map on a touchscreen of mobile user device 330. If the floor selection is ambiguous, e.g. because the accumulated change in altitude lies between the ranges of delta-altitudes provided for two subsequent floors, the evaluation may have to be performed for both floors to find the best match.

Alternatively, mobile user device 320 may send a positioning request including results of measurements on radio signals and atmospheric pressure to server 310. In this case, server 310 may perform the required positioning computations taking account of the stored radio map data and provide the result to requesting mobile user device 320 or to some other entity.

It is to be understood that the presented example systems, apparatuses and operations may be varied in many ways. The systems and apparatuses may be varied for instance by modifying, adding or omitting components. The operations may be varied for instance by modifying actions, by omitting actions and/or by adding actions. In addition, the order of actions may be modified. Furthermore, the distribution of actions between mobile data collection device 300 and server 310 may be changed.

For example, in an alternative embodiment, the radio transmitters 330 of FIG. 3 may include other transmitters than BLE beacons or WLAN access points that are considered in the data collection for radio maps. WLAN access points and Bluetooth beacons are already installed in many buildings. Furthermore, WLAN and Bluetooth technologies are supported by many mobile user devices by default, like by most smartphones, tablets, laptops and feature phones. Evaluating the received signal strength of signals transmitted by WLAN access points, Bluetooth beacons and/or BLE beacons may thus have the effect that the determined reference locations may be based in some embodiments on an existing infrastructure in buildings and/or be exploited with existing capabilities in many mobile devices. As a result, the approach may be globally scalable and have low maintenance and deployment costs. The deployment of new infrastructure, including for example beacons and tags, is possible but not necessary. In addition, the end-user experience may be acceptable with these technologies, since a horizontal positioning accuracy of 2-3 meters as well as close to 100% reliability in floor detection may be achieved. The radio transmitters may be stand-alone devices or be integrated into or attached to some other device. The use of Bluetooth low energy may limit the energy consumption at all involved devices. A Bluetooth beacon that is employed for the invention may be any kind of Bluetooth beacon complying with any present or future standard. It is to be understood, however, that other types of radio transmitters than variations of WLAN access points or Bluetooth beacons may be used as well, for instance tags or other devices that are configured to transmit ultra-wideband (UWB) signals or ultra-sound signals or any wireless signals that might emerge in the future. If the radio transmitters comprise alternatively or in addition a cellular transmitter, any of the radio transmitters may be for instance a base station of a Global System for Mobile Communications (GSM) network, of a CDMA2000 network, of a Universal Mobile Telecommunications System (UMTS) network, of a long term evolution (LTE) network, or of any other current or future kind of cellular network.

For example, in an alternative embodiment of the system of FIG. 3, the collection of data for determining floor heights may be separated from the collection of data for radio maps. A user of mobile data collection device 300 may be requested to systematically change floors in a building. For instance, the user may be requested to move from first floor to second floor and back, from first floor to third floor and back, etc., until two delta-altitudes (from upwards movement and downwards movement) for all possible floor pairs have been collected. In this case, the operations of FIG. 4 may be limited to actions 421 to 426, but the user would input a floor number after each change of floor for use in action 424. Accordingly, only delta-altitudes associated with floor pairs would be retrieved from memory 304 and transmitted to server 310 in action 431. This may have the effect that a subsequent collection of data based on radio measurements is improved from the start, as a particular new floor may be suggested at each change of floor. Furthermore, this may have the effect that floor heights for a particular building may be determined more efficiently, if the collection of data based on radio measurements is not needed in the particular building.

For example, in an alternative embodiment of the operations of FIG. 4, measurements on radio signals in line with action 411 may only be carried out whenever an indication of a position in a user input is detected in action 412.

For example, in alternative embodiments of the system of FIG. 3, the operations of FIG. 4 and FIG. 5 may be distributed in different manners to mobile data collection device 300 and server 310. In a first variation, mobile data collection device 300 may be responsible for carrying out actions 522 to 525 in addition. In this case, mobile data collection device 300 may provide only the final floor heights—and optionally assembled fingerprints—to server 310. In another variation, mobile data collection device 300 may only be used for actions 401, 411 to 413 and 421 to 423 of FIG. 4. That is, changes in altitude are tracked and accumulated with a moving time window approach and the accumulated value is continuously recorded, but it is not reset in-between. If the fingerprints assembled in action 413 are provided with a time stamp, server 310 may take care of matching the record with indicated floor in a post processing. In another variation, server 310 may even take care of actions 422 and 423 of FIG. 4 in addition.

Summarized, certain embodiments of the invention may enable the determination of floor heights of a building in a reliable way, in case such information is not readily available in site map data for the building. This may facilitate positioning of mobile user devices and/or improve the creation of radio maps for the building.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)
(b) combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Any of the memories mentioned in this text could be implemented as a single memory or as a combination of a plurality of distinct memories, and may comprise for example a read-only memory (ROM), a random access memory (RAM), a flash memory or a hard disc drive memory etc.

A bus may be provided for connecting processor(s) and memories.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

In example embodiments, any non-transitory computer readable medium mentioned in this text could also be a removable/portable storage or a part of a removable/portable storage instead of an integrated storage. Example embodiments of such a removable storage comprise a magnetic disc storage, of an optical disc storage, a semiconductor memory circuit device storage and of a Micro-SD semiconductor memory card storage.

The functions illustrated by processor 101 in combination with memory 102, or processor 311 in combination with memory 312, or component 313 (optionally in combination with processor 301 and memory 302 or component 303) can also be viewed as means for correlating tracked changes in altitude, which are based on data provided by a barometer or a pressure altimeter of a mobile device while a user of the mobile device moves around in a multi-story building, with changes of floors indicated via a user interface of the mobile device; means for determining heights of floors of the building based on the correlation; and means for causing storage of the determined heights of floors for future use.

The program codes in memory 102 and memory 312 (optionally in combination with the program code in memory 302) can also be viewed as comprising such means in the form of functional modules.

FIGS. 2, 4 and 5 may also be understood to represent example functional blocks of computer program codes supporting a selection of floors.

It will be understood that all presented embodiments are only examples, and that any feature presented for a particular example embodiment may be used with any aspect of the invention on its own or in combination with any feature presented for the same or another particular example embodiment and/or in combination with any other feature not mentioned. It will further be understood that any feature presented for an example embodiment in a particular category may also be used in a corresponding manner in an example embodiment of any other category.

1. A method comprising, performed by at least one apparatus:
correlating tracked changes in altitude, which are based on data provided by a barometer or a pressure altimeter of a mobile device while a user of the mobile device moves around in a multi-story building, with changes of floors indicated via a user interface of the mobile device;
determining heights of floors of the building based on the correlation; and
causing storage of the determined heights of floors for future use.

2. The method according to claim 1, further comprising:
tracking the changes in altitude based on the data provided by a barometer or a pressure altimeter of the mobile device while the user of the mobile device moves around in the multi-story building.

3. The method according to claim 1, wherein heights of floors of the building are determined based on data of a barometer or a pressure altimeter of a plurality of mobile devices and changes of floors indicated via a user input of the plurality of mobile devices, and/or data of a barometer or a pressure altimeter and changes of floors indicated via a user input collected at different occasions of a user of the mobile device moving around in the multi-story building.

4. The method according to claim 1, wherein determining heights of floors comprises determining delta-altitudes of floors for each of a plurality of floor pairs, the method further comprising in the case that a plurality of delta-altitudes are determined for a floor pair:
selecting an average of the determined plurality of delta-altitudes as a final delta-altitude for the floor pair; or
selecting a median of the determined plurality of delta-altitudes as a final delta-altitude for the floor pair; or
determining a range of the determined plurality of delta-altitudes as a final delta-altitude for the floor pair; and/or
discarding delta-altitudes that deviate in view of a predetermined criterion from other delta-altitudes of the plurality of delta-altitudes.

5. The method according to claim 1, a wherein determining heights of floors comprises determining the delta-altitudes of floors for each of a plurality of floor pairs of the building, at least one of the floor pairs being non-subsequent floors.

6. The method according to claim 5, further comprising verifying a delta-altitude determined for at least one floor pair of the building based on delta-altitudes determined for other floor pairs of the building.

7. The method according to claim 1, wherein correlating the changes in altitude with changes of floors indicated via a user interface of the mobile device comprises considering only changes in altitude that exceed a predetermined value within a moving time window.

8. The method according to claim 1, wherein the barometer data or pressure altimeter data and the floors indicated via the user interface of the mobile device are received during a collection of data for a radio map for the building.

9. The method according to claim 1, further comprising providing determined floor heights for one of:
positioning of mobile devices in the building;
supporting a correct selection of a floor during data collection for a radio map;
automatically detecting a floor in the building;
automatically detecting a floor in a crowd sourced data collection for a radio map in the building;
suggesting a floor to a user in the building, which is to be confirmed by the user;
verifying a floor input by a user in the building and for outputting a warning in the case of a discrepancy.

10. (canceled)

11. (canceled)

12. A system comprising at least one processor and at least one memory, wherein the at least one memory includes computer program code, the at least one memory and the computer program code configured to, with the at least one processor, cause at least one apparatus at least to:
correlate tracked changes in altitude, which are based on data provided by a barometer or a pressure altimeter of a mobile device while a user of the mobile device moves around in a multi-story building, with changes of floors indicated via a user interface of the mobile device;
determine heights of floors of the building based on the correlation; and
cause storage of the determined heights of floors for future use.

13. The system according to claim 12, wherein the at least one memory and the computer program code are further configured to, with the at least one processor, cause the at least one apparatus to:
track the changes in altitude based on the data provided by a barometer or a pressure altimeter of the mobile device while the user of the mobile device moves around in the multi-story building.

14. The system according to claim 12, wherein heights of floors of the building are determined based on data of a barometer or a pressure altimeter of a plurality of mobile devices and changes of floors indicated via a user input of the plurality of mobile devices, and/or data of a barometer or a pressure altimeter and changes of floors indicated via a user input collected at different occasions of a user of the mobile device moving around in the multi-story building.

15. The system according to claim 12, wherein determining heights of floors comprises determining delta-altitudes of floors for each of a plurality of floor pairs, the at least one memory and the computer program code further configured to, with the at least one processor, cause the at least one apparatus, in the case that a plurality of delta-altitudes are determined for a floor pair, to:
select an average of the determined plurality of delta-altitudes as a final delta-altitude for the floor pair; or
select a median of the determined plurality of delta-altitudes as a final delta-altitude for the floor pair; or
determine a range of the determined plurality of delta-altitudes as a final delta-altitude for the floor pair; and/or
discard delta-altitudes that deviate in view of a predetermined criterion from other delta-altitudes of the plurality of delta-altitudes.

16. The system according to claim 12, wherein determining heights of floors comprises determining the delta-altitudes of floors for each of a plurality of floor pairs of the building, at least one of the floor pairs being non-subsequent floors.

17. The system according to claim 16, wherein the at least one memory and the computer program code are further configured to, with the at least one processor, cause the at least one apparatus to verify a delta-altitude determined for at least one floor pair of the building based on delta-altitudes determined for other floor pairs of the building.

18. The system according to claim 12, wherein correlating the changes in altitude with changes of floors indicated via a user interface of the mobile device comprises considering only changes in altitude that exceed a predetermined value within a moving time window.

19. The system according to claim 12, wherein the barometer data or pressure altimeter data and the floors indicated via the user interface of the mobile device are received during a collection of data for a radio map for the building.

20. The system according to claim 12, wherein the at least one memory and the computer program code are further configured to, with the at least one processor, cause the at least one apparatus to provide determined floor heights for one of:
positioning of mobile devices in the building;
supporting a correct selection of a floor during data collection for a radio map;
automatically detecting a floor in the building;
automatically detecting a floor in a crowd sourced data collection for a radio map in the building;
suggesting a floor to a user in the building, which is to be confirmed by the user; or
verifying a floor input by a user in the building and for outputting a warning in the case of a discrepancy.

21. The system according to claim 12, wherein the system:
is a mobile device; or
is a module for a mobile device; or
comprises at least one mobile device; or
is a server; or
is a module for a server; or
comprises at least one server; or
comprises at least one mobile device and at least one server.

22. (canceled)

23. A non-transitory computer readable storage medium in which computer program code is stored, the computer program code causing at least one apparatus to perform the following when executed by at least one processor:
correlate tracked changes in altitude, which are based on data provided by a barometer or a pressure altimeter of a mobile device while a user of the mobile device moves around in a multi-story building, with changes of floors indicated via a user interface of the mobile device;
determine heights of floors of the building based on the correlation; and
cause storage of the determined heights of floors for future use.
